(19) United States
(12) Patent Application Publication
(10) Pub. No.: US 2022/0015557 A1
(43) Pub. Date: Jan. 20, 2022

(54) FRAMING SYSTEMS AND METHODS OF ASSEMBLING SAME

(71) Applicant: Frame My TV, Methuen, MA (US)

(72) Inventors: Richard Jordan, Methuen, MA (US); Randal Davis, Methuen, MA (US); Kevin Hancock, Methuen, MA (US)

(21) Appl. No.: 17/490,481

(22) Filed: Sep. 30, 2021

Related U.S. Application Data
(63) Continuation of application No. PCT/IB2020/059868, filed on Oct. 20, 2020.
(60) Provisional application No. 62/923,856, filed on Oct. 21, 2019.

(51) Int. Cl. A47G 1/10

(52) U.S. Cl. CPC A47G 1/10; A47G 2001/0672

(57) ABSTRACT

The disclosure relates to framing systems, methods of framing various items, and framing kits, including the use of magnetic fastening systems for securing mitered corners.

### TECHNICAL FIELD

Generally, the disclosure relates to framing systems, methods of framing various items, and framing kits. In particular, the disclosure relates to magnetic fastening systems for securing mitered corners.

### SUMMARY

In one aspect, the disclosure relates to a framing system including two elongate horizontal members, two elongate vertical members, and a plurality of fastening mechanisms. Each member includes a body and two opposing ends, where each opposing end comprises a first or second half of a miter joint. The fastening mechanisms include a plurality of first magnetic components disposed on the opposing ends of the two horizontal members and a plurality of second magnetic components, each having a polarity opposite of the first magnetic components, disposed on the opposing ends of the two vertical members. For assembly, at least one of the plurality of first magnetic components mates with at least one of the second magnetic components to form a joint between at least one of the horizontal members and at least one of the vertical members.

In various embodiments, each of the horizontal member opposing ends and each of the vertical member opposing ends includes an end face and the plurality of first and second magnetic components are disposed on their respective end faces. The opposing ends of the horizontal members may have a first alignment mechanism configured to interface with a second alignment mechanism disposed on the opposing ends of the vertical members. In some embodiments, the magnetic components may be disc magnets embedded within their respective opposing ends. For example, the magnets can be secured within the opposing ends via an interference fit within a receptacle formed in the end face, held in place by an adhesive, or secured via a mechanical fastener, such as a screw. In certain embodiments, a magnetic end plate attached to and covering substantially the entire end face may be used. Such a plate may include alignment mechanisms as described below or have clearance openings to accommodate them. Typically, there are two fastening mechanisms per joint (i.e., connected opposing ends); however, the number, placement, and strength of the fastening mechanisms can vary to suit a particular application, such as the overall size, shape, and weight of the frame or the nature of the item captured by the frame. For example, for a narrow frame, it is possible only one or two fastening mechanisms are required; however, for a wider frame, it may be necessary to have two to four fastening mechanisms. Alternatively, if magnetic plates are used, the size and shape of the plates may be varied to suit a particular application.

In further embodiments of the system, the first and second alignment mechanisms may include mating female and male components, such as a dowel pin and a cylindrical recess, which may be mounted on either opposing ends, e.g., dowels on the horizontal members and recesses on the vertical members, or vice-versa. Additionally, at least one of the horizontal or vertical members may define one or more receptacles, such as a through opening in the member or merely a recess disposed therein. In some embodiments, the receptacle is configured to at least partially house (e.g., sized and shaped with or without fastening means, such as mechanical fasteners, an adhesive, a frictional fit, etc.) a piece of auxiliary equipment, such as an optical router. Furthermore, each elongate horizontal and vertical members may have a front face and a back face, where the back faces define at least a partial recess for engaging an item to be framed, such as a housing of a television, a work of art, etc. In certain embodiments, the framing system is configured to interface with a television or other electronic screen, such as computer monitor, tablets, etc. The framing system may also include a latch mechanism for securing the frame to an item to be framed.

In another aspect, the disclosure relates to a method of assembling a frame. The method includes the steps of providing two elongate horizontal members and providing two elongate vertical members, where each member includes a body and two opposing ends and each opposing end defines a first or second half of a miter joint; aligning a first opposing end of a first elongate horizontal member with a first opposing end of a first elongate vertical member; and coupling the first opposing end of the first elongate horizontal member with the first opposing end of the first elongate vertical member via a first fastening mechanism, wherein the first fastening mechanism comprises a first magnetic component disposed on the first opposing end of the first elongate horizontal member and a second magnetic component disposed on the first opposing end of the first elongate vertical member.

The process then continues with the other corners, specifically aligning a second opposing end of the first elongate horizontal member with a first opposing end of a second elongate vertical member; coupling the second opposing end of the first elongate horizontal member with the first opposing end of the second elongate vertical member via a second fastening mechanism, wherein the second fastening mechanism comprises a first magnetic component disposed on the second opposing end of the first elongate horizontal member and a second magnetic component disposed on the first opposing end of the second elongate vertical member; aligning a first opposing end of a second elongate horizontal member with a second opposing end of the first elongate vertical member; aligning a second opposing end of the second elongate horizontal member with a second opposing end of the second elongate vertical member; and coupling the first and second opposing ends of the second elongate horizontal member with the second opposing ends of the first and second elongate vertical members via third and fourth fastening mechanisms, wherein the fastening mechanisms comprise first and second magnetic components disposed on the opposing ends of the second elongate horizontal member and the second opposing ends of the first and second elongate vertical member. Alternatively, all of the joints/corners (i.e., the opposing ends) can be aligned substantially at once as shown in FIG. 4A.

In various embodiments of the method, the aligning steps include joining a first alignment mechanism disposed on at least one of the horizontal or vertical members with a second alignment mechanism disposed on an opposing member. Generally, the alignment mechanisms are used to precisely align the corner(s), while the magnetic fastening mechanisms are what join the corner(s). In some cases, the magnetic forces not only secure the members to each other once connected, but can assist in pulling the opposing ends into contact. An additional step includes securing at least one of the first or second horizontal members or at least one of the first or second vertical members to the item to be framed, such as a television, a work of art, etc. In some embodiments, the frame is essentially completely assembled before being secured to the item to be framed. The frame can be secured to the item via one or more latching mechanisms.

In yet another aspect, the disclosure relates to a kit for a framing system. Generally, the kit includes two elongate horizontal members and two elongate vertical members, where each member has a body and two opposing ends that define either a first or a second half of a miter joint, and a plurality of fastening mechanisms. Each fastening mechanism may include a first magnetic component and a second magnetic component having a polarity opposite of the first magnetic component. The kit can include one or more sets of components for assembling a framing system that may be customized based on the particular set of components used, for example, multiple sets of horizontal and vertical members may be included so that a user can assemble frames having different shapes and sizes. The kit will typically also include a set of assembly instructions.

In various embodiments, the kit may also include a plurality of alignment mechanisms, wherein each alignment mechanism has a first component and a second mating component. In some embodiments, the fastening and/or alignment mechanisms may be provided pre-assembled on the elongate members.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and can exist in various combinations and permutations.

Numerous other aspects, features and benefits of the present disclosure may be made apparent from the following detailed description taken together with the drawing figures. The pharmaceutical compositions can include nucleic acid constructs described herein along with other components, or ingredients depending on desired prevention and treatment goals. It should be further understood that both the foregoing general description and the following detailed description are exemplary and explanatory and are intended to provide further explanation of the disclosure as claimed.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure and are not intended as a definition of the limits of the disclosure. For purposes of clarity, not every component may be labeled in every drawing. In the following description, various embodiments of the present disclosure are described with reference to the following drawings, in which:

FIG. 1 is a pictorial representation of an assembled framing system in accordance with one or more embodiments of the disclosure;

FIGS. 2A and 2B are schematic representations of an enlarged view of a portion of the framing system of FIG. 1 in accordance with one or more embodiments of the disclosure;

FIG. 3 is a pictorial representation of the installation of an assembled framing system in accordance with one or more embodiments of the disclosure; and

FIGS. 4A-4D are pictorial representations of one method of installing the framing system of FIG. 1 in accordance with one or more embodiments of the disclosure.

### DETAILED DESCRIPTION

Reference will now be made to the exemplary embodiments illustrated in the drawings, and specific language will be used here to describe the same. It will nevertheless be understood that no limitation of the scope of the disclosure is thereby intended. Alterations and further modifications of the inventive features illustrated here, and additional applications of the principles of the disclosures as illustrated here, which would occur to one skilled in the relevant art and having possession of this disclosure, are to be considered within the scope of the disclosure. For example, the framing systems described herein can be used to frame essentially any type of electronic screen, as opposed to only flat screen televisions. Additionally, the methods of assembling and fastening the various components of the system can be applied to other items, such as a work of art, an aquarium, etc.

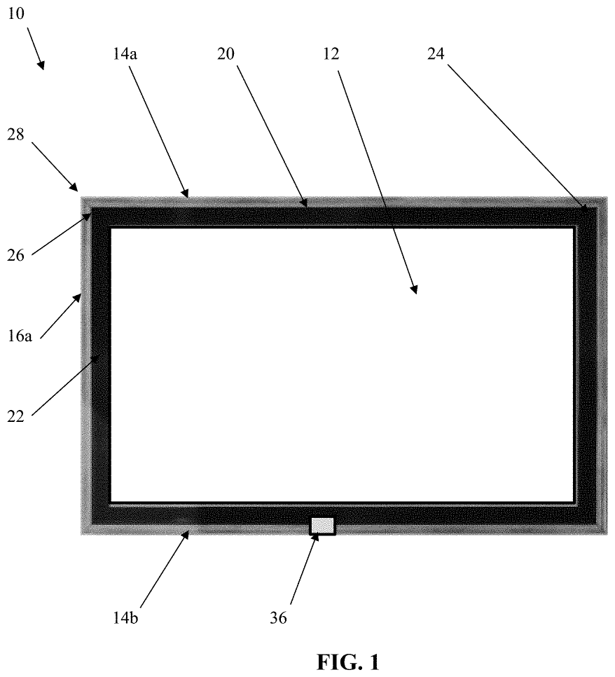

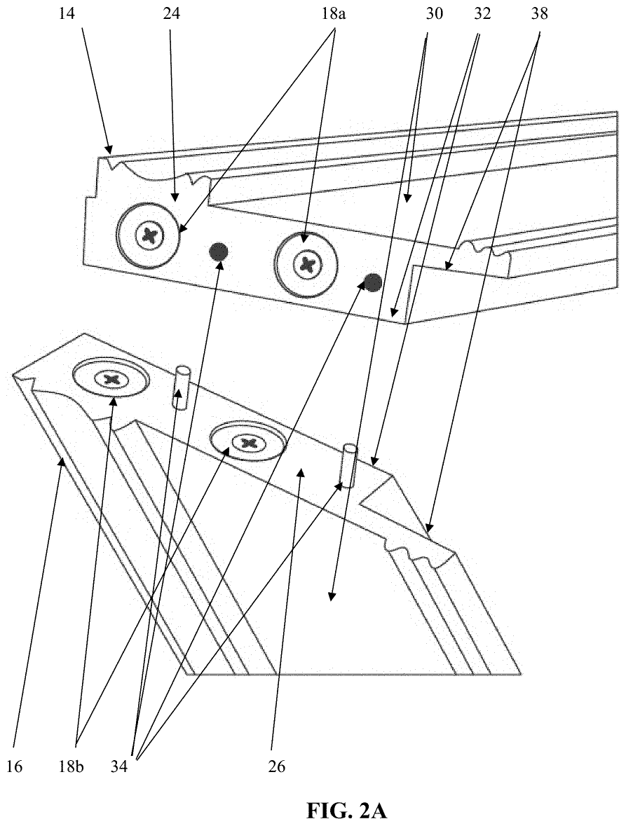

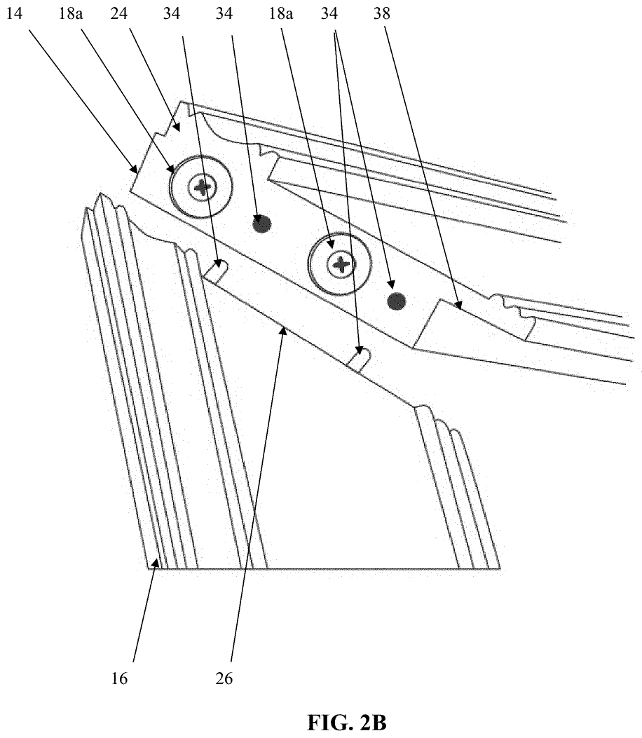

FIG. 1 depicts a first embodiment of a framing system 10 that can be used to frame a television or other electronic screen 12. As shown, the system 10 includes two elongate horizontal members 14a, 14b, two elongate vertical members 16a, 16b, and a plurality of fastening mechanisms 18 (see FIG. 2). Each of the elongate members 14, 16 have a body portion 20, 22 and opposing ends 24, 26. Typically, the opposing ends 24, 26 will form first and second halves of a mitered joint 28. Each of the elongate members 14, 16 will also have a front face 30 and an opposite back face 32. As shown, the elongate members have generally rectangular shapes; however, the shapes and profiles of the elongate members can vary to suit a particular frame design, for example, rectangular or circular, or any combination of polygonal and arcuate shapes. In various embodiments, the elongate members 14, 16 can be made of a wood, a polymer, a metal or combinations thereof.

Additionally, one of the elongate members 14, 16 can include a receptacle or other type of opening or access means 36 that can be used to house, for example, but not limited to, an optical router for enabling communication between the television 12 and a remote control. Alternatively or additionally, the access means 36 can be a small opening in one of the members that aligns with a sensor or other type of control, thereby providing access thereto.

FIGS. 2A and 2B depict the fastening mechanisms 18 and the basic method of assembling the frame. Specifically, FIG. 2A depicts the two mating opposing ends 24, 26, while FIG. 2B depicts a vertical member 16 being aligned with the horizontal member 14. Generally, each fastening mechanism 18 includes a first magnetic component 18a disposed on an opposing end 24 of a horizontal member 14 and a second magnetic component 18b having a polarity opposite of the first magnetic component disposed on a mating opposing end 26 of a vertical member 16. In certain embodiments, the magnets can be N45 neodymium ½″×¼″ disc magnets, such as model no. ND033-N454C as available from Applied Magnets. In addition, the framing system can include alignment mechanisms 34 to assist in the assembly of the frame. As shown in FIGS. 2A and 2B, the alignment mechanism 34 is made up of a post and a mating receptacle; however, other alignment mechanisms are contemplated and considered within the scope of the disclosure. Once the horizontal and vertical members 14, 16 are aligned, the opposing ends can be brought into contact with each other or at least proximate one another so that the magnetic components will be attracted to one another to securely couple the elongate members, thereby completing the mitered joint 28. In some embodiments, the alignment mechanism can also be magnetic to further assist with joining the corners and/or to replace separate/additional magnets.

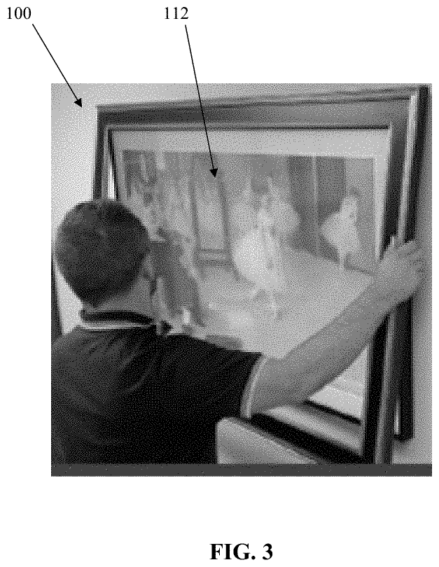

FIG. 3 depicts a user coupling the assembled frame 100 to a television 112; however, as disclosed above, the frame can be used to capture any number items. Typically, the back faces 32 of the elongate members have a recess 38 (see FIGS. 2A and 2B) on their inner edges, so that when the frame is assembled, a receptacle having a shape corresponding to an outside shape of an item to be framed is formed, such as, for example, a rectangular shape of a television. This receptacle allows the frame 100 to fit over the item to be framed. In some embodiments, the frame is held in place by the frictional fit between the receptacle and the outer perimeter or surface of the item. In various other embodiments, the assembled frame may be held in place via a snap fit, a set screw through one of the elongate members, clips or other methods as known to a person of ordinary skill in the art. In alternative embodiments, one or more of the elongate members can be secured to the item prior to assembly and the remaining elongate members then secured thereto.

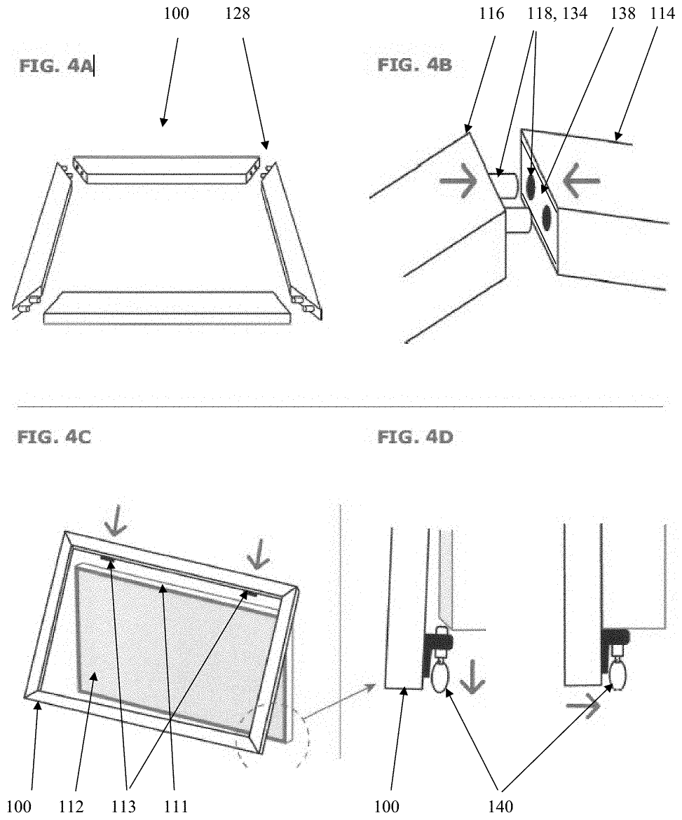

FIGS. 4A-4D depict an alternative assembly method. As shown in FIG. 4A, the horizontal and vertical members of the frame assembly 100 can be arranged on a substantially flat surface with their opposing ends positioned proximate one another to form the completed joints 128. As shown in FIG. 4B, each pair of a horizontal and vertical members can be brought into alignment via the alignment mechanism 134 and secured via the fastening mechanisms 118. In some embodiments, the fastening and alignment mechanisms may be integrally formed. However, in other embodiments, an optional, separate magnetic plate 138 may be secured to each of the opposing ends including cut-outs for accommodating the alignment mechanism. FIGS. 4C and 4D depict the finished frame assembly 100 being secured to the item to be framed 112. In one embodiment, the frame 100 is hooked to a top edge 111 of the item 112 via one or more projections 113 that can be configured to hook onto, or otherwise grip, the top edge 111 of the item 112. In some cases, the projections 113 may work in conjunction with the recesses 38 described above to help secure the frame 100 to the item 112. FIG. 4D is an enlarged side view of a lower edge of the frame assembly 100 depicting a latching mechanism 140 that can be used to secure the frame 100 to the item 112. The latching mechanism can be operated, for example, via a linkage, threaded components, as cam arrangement, a magnetic component, or a spring.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives.

Furthermore, those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto; the disclosure may be practiced other than as specifically described.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

What is claimed is:

1. A framing system comprising:
two elongate horizontal members, each comprising a body and two opposing ends, wherein each opposing end comprises a first half of a miter joint;
two elongate vertical members, each comprising a body and two opposing ends, wherein each opposing end comprises a second half of a miter joint; and
a plurality of fastening mechanisms, wherein each fastening mechanism comprises:
a plurality of first magnetic components disposed on the opposing ends of the two horizontal members; and
a plurality of second magnetic components, each having a polarity opposite of the first magnetic components, disposed on the opposing ends of the two vertical members,
wherein at least one of the plurality of first magnetic components mates with at least one of the second magnetic components to form a joint between at least one of the horizontal members and at least one of the vertical members.

2. The system of claim 1, wherein each of the horizontal member opposing ends and each of the vertical member opposing ends comprises an end face and the plurality of first and second magnetic components are disposed on their respective end faces.

3. The system of claim 1, wherein the opposing ends of the horizontal members comprise a first alignment mechanism configured to interface with a second alignment mechanism disposed on the opposing ends of the vertical members.

4. The system of claim 1, wherein the magnetic components comprise disc magnets embedded within their respective opposing ends.

5. The system of claim 1, wherein the first and second alignment mechanisms comprise mating female and male components.

6. The system of claim 1, wherein at least one of the horizontal or vertical members defines a receptacle.

7. The system of claim 6, wherein the receptacle is configured to at least partially house a piece of auxiliary equipment, such as an optical router.

8. The system of claim 1, wherein the elongate horizontal and vertical members comprise a front face and a back face and the back faces define at least a partial recess for engaging an item to be framed.

9. The system of claim 1, wherein the framing system is configured to interface with a television or other electronic screen, such as computer monitor, tablets, etc.

10. The system of claim 1, wherein the framing system further comprises a latch mechanism for securing the frame to an item to be framed.

11. The system of claim 1, wherein the plurality of fastening mechanisms comprise one or more magnetic plates.

12. A method of assembling a frame, the method comprising the steps of:
providing two elongate horizontal members, each comprising a body and two opposing ends, wherein each opposing end comprises a first half of a miter joint;
providing two elongate vertical members, each comprising a body and two opposing ends, wherein each opposing end comprises a second half of a miter joint;
aligning a first opposing end of a first elongate horizontal member with a first opposing end of a first elongate vertical member;
coupling the first opposing end of the first elongate horizontal member with the first opposing end of the first elongate vertical member via a first fastening mechanism, wherein the first fastening mechanism comprises a first magnetic component disposed on the first opposing end of the first elongate horizontal member and a second magnetic component disposed on the first opposing end of the first elongate vertical member;
aligning a second opposing end of the first elongate horizontal member with a first opposing end of a second elongate vertical member;
coupling the second opposing end of the first elongate horizontal member with the first opposing end of the second elongate vertical member via a second fastening mechanism, wherein the second fastening mechanism comprises a first magnetic component disposed on the second opposing end of the first elongate horizontal member and a second magnetic component disposed on the first opposing end of the second elongate vertical member;
aligning a first opposing end of a second elongate horizontal member with a second opposing end of the first elongate vertical member;
aligning a second opposing end of the second elongate horizontal member with a second opposing end of the second elongate vertical member; and
coupling the first and second opposing ends of the second elongate horizontal member with the second opposing ends of the first and second elongate vertical members via third and fourth fastening mechanisms, wherein the fastening mechanisms comprise first and second magnetic components disposed on the opposing ends of the second elongate horizontal member and the second opposing ends of the first and second elongate vertical member.

13. The method of claim 12, wherein the aligning steps comprise joining a first alignment mechanism disposed on at least one of the horizontal or vertical members with a second alignment mechanism disposed on an opposing member end.

14. The method of claim 12 further comprising securing at least one of the first or second horizontal members or at least one of the first or second vertical members to an electronic screen, such as a television.

15. A kit for a framing system, the kit comprising:
a set of two elongate horizontal members, each comprising a body and two opposing ends, wherein each opposing end comprises a first half of a miter joint;
a set of two elongate vertical members, each comprising a body and two opposing ends, wherein each opposing end comprises a second half of a miter joint; and
a plurality of fastening mechanisms, wherein each fastening mechanism comprises a first magnetic component and a second magnetic component having a polarity opposite of the first magnetic component.

16. The kit of claim 15 further comprising a plurality of alignment mechanisms, wherein each alignment mechanism comprises a first component and a second mating component.

17. The kit of claim 16, wherein at least one of the fastening mechanisms or the alignment mechanisms are pre-assembled onto the elongate members.

18. The kit of claim 14 further comprising a latching mechanism configured to attach to one or more of the elongate members and secure an assembled frame to an item to be framed.

19. The kit of claim 14 further comprising additional sets of horizontal and vertical members having different lengths
